(19) United States
(12) Patent Application Publication
(10) Pub. No.: US 2008/0014493 A1
(43) Pub. Date: Jan. 17, 2008

(54) FUEL CELL HAVING WATER RECIRCULATION PLATE

(75) Inventors: Jae-yong Lee, Yongin-si (KR); Jin-ho Kim, Yongin-si (KR); Kyoung-hwan Choi, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/773,708

(22) Filed: Jul. 5, 2007

(30) Foreign Application Priority Data
Jul. 5, 2006 (KR) 2006-63125

(51) Int. Cl. H01M 8/04; H01M 2/18

(52) U.S. Cl. 429/39

(57) ABSTRACT

A planar type fuel cell is provided. The planar type fuel cell has a membrane electrode assembly including an electrolyte membrane and an anode, and a cathode, and a plate attached to the cathode of the membrane electrode assembly to supply water to the cathode by condensing water vapor generated from the cathode.

### CROSS-REFERENCE TO RELATED PATENT APPLICATIONS

This application claims the benefit of Korean Application No. 2006-63125, filed Jul. 5, 2006, in the Korean Intellectual Property Office, the disclosure of which is incorporated herein in its entirety by reference.

### BACKGROUND OF THE INVENTION

1. Field of the Invention

Aspects of the present invention relate to a fuel cell, and more particularly, to a fuel cell having a plate which supplies water to a cathode by condensing water vapor generated by the cathode.

2. Description of the Related Art

Fuel cells include direct methanol fuel cells (DMFC) and polymer electrolyte fuel cells (PEMFC), among others. The DMFC is a possible replacement for the traditional battery as the supply of fuel is easily accessible and the output density is higher than that of a battery; however, the DMFC has a lower output density than the PEMFC. DMFCs are generally bipolar fuel cells, but the stacks of the replacement batteries for PDAs (personal digital assistants), mobile phones, and laptops are generally a monopolar type.

A variety of monopolar type DMFCs has been introduced. Of the monopolar type DMFCs that have been introduced (hereinafter, referred to as the conventional DMFC), a planar type has a cathode in which the entire outer surface is exposed to the atmosphere. Thus, a large amount of water vapor generated from the cathode is lost. Also for the conventional DMFC, it is difficult to increase the output power density.

### SUMMARY OF THE INVENTION

To solve the above and/or other problems, aspects of the present invention provide a planar type fuel cell which can minimize the loss of water and increase the output power density of the fuel cell by condensing water evaporated from the cathode and reusing the condensed water.

According to an aspect of the present invention, there is provided a planar type fuel cell comprising a membrane electrode assembly including an electrolyte membrane, an anode, and a cathode; and a plate attached to the cathode of the membrane electrode assembly, wherein the plate condenses water vapor generated by the cathode and supplies the condensed water to the cathode, and the plate resists the absorption of water.

According to an aspect of the invention, a space where the water vapor generated from the cathode may be collected and condensed is provided on the plate.

According to an aspect of the invention, the plate may comprise a plurality of protrusions the tips of which contact the membrane electrode assembly and the plate is separated from the membrane electrode assembly around the protrusions.

According to an aspect of the invention, the protrusions may be arranged in a grid pattern.

According to an aspect of the invention, the protrusions may be circular cones, polygonal cones, or pillars.

According to an aspect of the invention, wrinkles or grooves may be longitudinally formed on surfaces of the protrusions in a direction from the bottom of each of the protrusions toward the top thereof.

According to an aspect of the invention, the plurality of structures may be formed on the plate in a grid pattern without contacting the membrane electrode assembly.

According to an aspect of the invention, the protrusions may be located around each of the structures.

According to an aspect of the invention, a plurality of trenches may be formed on the plate by the protrusions and the structures.

According to an aspect of the invention, the wrinkles may exist on an outer surface of the plate.

According to an aspect of the invention, the wrinkles may exist on the overall or part of the outer surface of the plate.

According to an aspect of the invention, a groove having the same shape as that of each protrusion may be formed at a position of an outer surface of the plate to correspond to each protrusion.

According to an aspect of the invention, the structures may have surfaces facing the membrane electrode assembly which is circular or polygonal.

According to an aspect of the invention, the structures may be circular cones or polygonal cones.

According to another aspect of the invention, a water recirculation plate for a fuel cell having a membrane electrode assembly with a cathode is provided, including: an outer surface, and an inner surface having protrusions extending therefrom, wherein the plate resists the absorption of water, captures water vapor produced by the cathode, condenses the water vapor on the inner surface of the plate, and supplies the condensed water vapor to the membrane electrode assembly.

According to an aspect of the invention, the protrusions extend from the inner surface of the plate to contact a membrane electrode assembly.

According to an aspect of the invention, the protrusions have at least a groove longitudinally formed on a surface of each protrusion of the plurality of protrusions.

According to an aspect of the invention, the plate may further include structures on the inner surface of the plate between the protrusions, wherein the structures extend from the inner surface of the plate but extend less than the protrusions.

According to an aspect of the invention, the protrusions and the structures are arranged in a grid, each individual protrusion is surrounded by a number of the structures, and each individual structure is surrounded by a number of the protrusions.

According to an aspect of the invention, each protrusion is surrounded by four structures, and each structure is surrounded by four protrusions.

According to an aspect of the invention, the outer surface of the plate has cooling grooves.

According to an aspect of the invention, the cooling grooves of the outer plate correspond to the protrusions of the inner plate.

According to an aspect of the invention, the protrusions form trenches in which air flows between the plate and the membrane electrode assembly.

According to an aspect of the invention, the protrusions and the structures for trenches in which air flows between the plate and the membrane electrode assembly.

According to an aspect of the invention, the plate may further include heat removal pipes between the outer surface and the inner surface.

According to aspects of the present invention, by using the fuel cell according to the present invention, the amount of water lost from the cathode can be minimized and water can be supplied from the plate to the cathode. Accordingly, the outpour power density can be increased and the hydration status of the membrane can be continuously maintained in a state proper for the transfer of the hydrogen ions (H+). Also, since the structure of the plate is simple, the manufacturing of the fuel cell is made easy.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a fuel cell according to an embodiment of the present invention;

FIG. 2 is a perspective view showing a face opposite to the cathode of the plate of FIG. 1;

FIG. 3 is an enlarged view of part of the plate shown in FIG. 2;

FIG. 4 is a cross-sectional view taken along line 4-4′ of FIG. 3;

FIG. 5 is a cross-sectional view taken along line 5-5′ of FIG. 3;

FIG. 6 is a cross-sectional view showing wrinkles formed in the outer surface of the plate of FIG. 1;

FIG. 7 is a cross-sectional view showing wrinkles formed in the outer surface of the plate of FIG. 1;

FIG. 8 is a cross-sectional view showing the evaporation/condensation of water vapor generated from the cathode turning into water on the plate and supplied to the cathode in the fuel cell shown in FIG. 1;

FIG. 9 is a graph showing the measured power density versus operation time; and

FIG. 10 is a graph showing the measured voltage and power versus current.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The embodiments are described below in order to explain aspects of the present invention by referring to the figures.

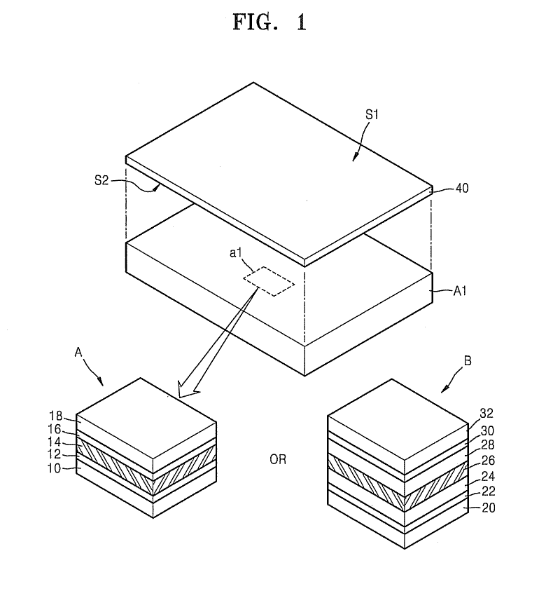

Referring to FIG. 1, a fuel cell according to an embodiment of the present invention includes a membrane electrode assembly (MEA) A1, having an electrolyte membrane, an anode, and a cathode, and a plate 40 attached on the upper surface of the MEA A1. The plate 40 condenses water vapor generated from the cathode 18 of the MEA A1 and supplies water to the cathode 18. The plate 40 does not readily absorb water. The MEA A1 may have a variety of structures. For example, as indicated by an enlarged portion A of FIG. 1 showing the structure of a partial area a1 of the MEA A1, the MEA A1 includes an anode 10, a first current collector 12, an electrolyte membrane (electrolyte film) 14, a second current collector 16, and a cathode 18, which are sequentially deposited. The MEA A1 may also include, as indicated by an enlarged portion B of FIG. 1, a first diffusive layer 20, a first current collector 22, an anode 24, a membrane 26, a cathode 28, a second current collector 30, and a second diffusive layer 32, which are sequentially deposited. The plate 40 is attached to the top layer of the MEA A1. As represented in enlarged portions A and B, the plate 40 may be attached to the cathode 18 or the second diffusive layer 32.

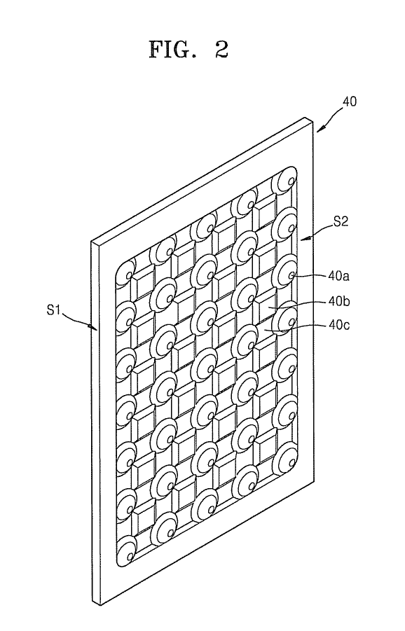

The plate 40 has an outer surface S1 and an inner surface S2, which faces the cathode 18 or the second diffusive layer 32 of the MEA A1. The inner surface S2 of the plate 40 includes a plurality of protrusions 40a formed in a grid pattern as shown in FIG. 2. A sharp tip of each of the protrusions 40a contacts the MEA A1. Due to the protrusions 40a, trenches 40c are formed through which air can flow to the cathode 18 between the MEA A1 and the other portion of the plate 40 around the protrusions 40a. Although the protrusions 40a are illustrated as circular cones, other polygonal cones such as rectangular, triangular, or pentagonal cones can be used. Also, the protrusions 40a may be pillars, for example, polygonal pillars such as circular, triangular, or rectangular pillars. There may be a wrinkle or a groove (not shown) formed longitudinally on the surface of the protrusions 40a. That is, the wrinkle or groove is formed in a direction from the bottom of each of the protrusions 40a toward the top thereof, or the wrinkle or groove is formed on the surface each of the protrusions 40a from the inner surface S2 to the tips of the protrusions 40a.

A plurality of structures 40b is further provided with the protrusions 40a on the inner surface S2 that faces the MEA A1 of the plate 40. The structures 40b are formed in a grid pattern with the protrusions 40a. Although each of the structures 40b is illustrated as a rectangle, the structures 40b may have other shapes such as circular, triangular, or the same shape as the protrusions 40a. Each protrusion 40a is surrounded by four of the structures 40b, and each of the structures 40b is surrounded by a plurality of the protrusions 40a, for example, four protrusions.

The protrusions 40a provide a path by which water droplets formed on the plate 40 move toward the MEA A1. The condensed water moves toward the cathode 18 or the second diffusive layer 32 of the MEA A1 along the surfaces of the protrusions 40a. A plurality of trenches 40c is formed on the plate 40 and provides a space for collecting water vapor evaporated by the cathode 18 of the MEA A1. When the plate 40 is not provided with the structures 40b, the water vapor can be collected in all the space between the protrusions 40a. The water vapor collects in the trenches 40c and condenses on the plate 40. As a result, water droplets are formed on the surface of the protrusions 40a and supplied to the MEA A1 along the surfaces of the protrusions 40a. The water droplets are also formed on the side surfaces of the structures 40b. The water droplets formed on the side surfaces of the structures 40b move to the protrusions 40a along the side surfaces of the structures 40b and then toward the cathode 18 or the second diffusive layer 32 of the MEA A1 along the surfaces of the protrusions 40a. Each of the trenches 40c is an area made by two neighboring protrusions 40a and two neighboring structures 40b, as shown in FIG. 2.

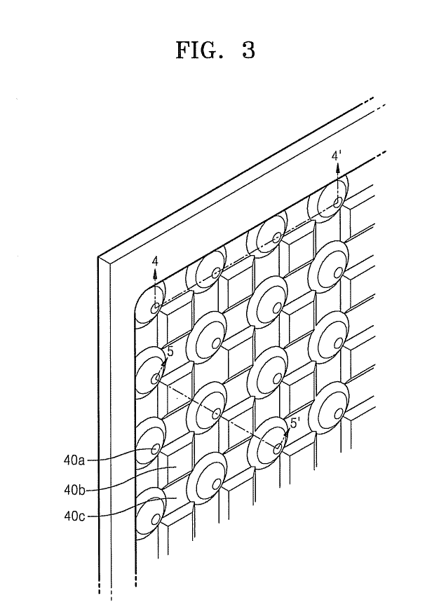

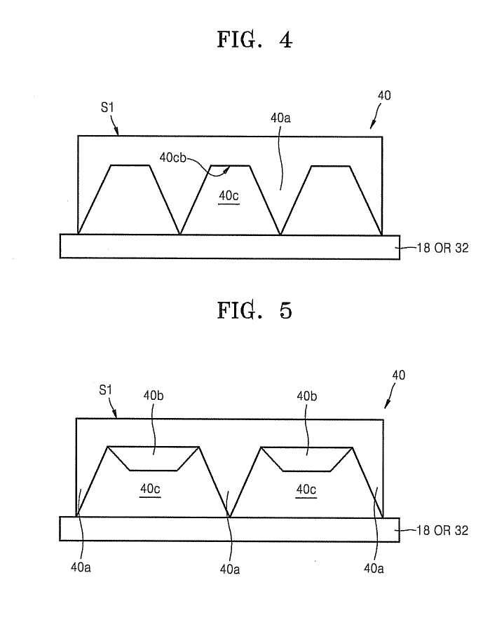

FIG. 3 is an enlarged view of part of the plate shown in FIG. 2. FIG. 4 is a cross-sectional view taken along line 4-4′ of FIG. 3. FIG. 5 is a cross-sectional view taken along line 5-5′ of FIG. 3. Referring to FIGS. 3 through 5, the shapes of the protrusions 40a, the structures 40b, and the trenches 40c can be seen in detail.

Referring to FIG. 4, the protrusions 40a are formed opposite the outer surface S1 on the plate 40 extending from the plate 40 toward the cathode 18 or the second diffusive layer 32 of the MEA A1. FIG. 4 illustrates aspects of this invention wherein the plate 40 only includes the protrusions 40a and the trenches 40c and excludes the structures 40b. As such, the trenches 40c provide area in which water vapor may collect and then condense on the bottoms 40cb of the trenches 40c and the surfaces of the protrusions 40a. The condensed water then returns to the cathode 18 or the second diffusive layer 32 of the MEA A1 along the surface of the protrusions 40a.

Referring to FIG. 5, the protrusions 40a and the structures 40b are formed opposite the outer surface S1 and extend from the plate 40 toward the cathode 18 or the second diffusive layer 32 of the MEA A1. However, as illustrated, the protrusions 40a extend to and contact the cathode 18 or the second diffusive layer 32 while the structures 40b only extend into the trenches 40c. Thus, the structures 40b do not contact the cathode 18 or the second diffusive layer 32 of the MEA A1. Accordingly, the water vapor can move through the trenches 40c about the protrusions 40a, the structures 40b, and the cathode 18 or the second diffusive layer 32 of the MEA A1. The structures 40b may have a similar shape as the protrusions 40b; for example, when the protrusions 40b are circular cones as shown in the drawing, the structures 40b may be circular cones. Also, the structures 40b can be removed, as illustrated in FIG. 3. The presence of the structures 40b affects the time for the water droplets to form and to move toward the cathode 18 or the second diffusive layer 32 of the MEA A1.

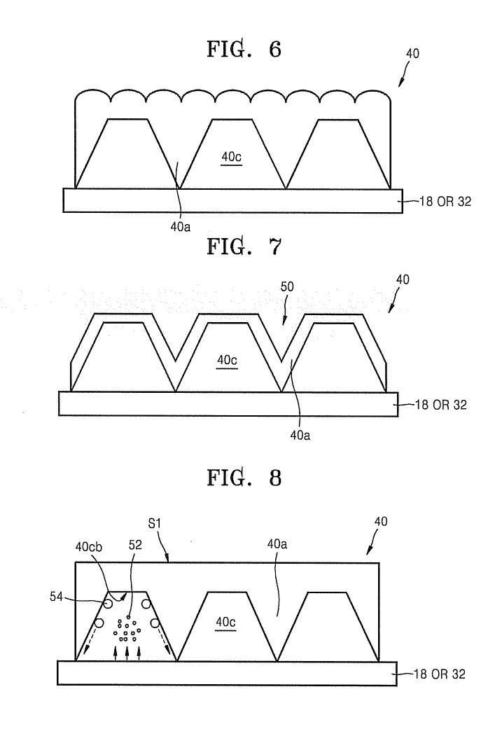

In order to increase the rate of condensation of the water vapor collected in the trenches 40c and decrease the time necessary to form water droplets on the surfaces of the protrusions 40a, the temperatures of the plate 40, the protrusions 40a, and the structures 40b need to be lowered so as to dissipate the heat of the water vapor to the outside the plate 40. Thus, to lower the temperatures of the plate 40, the protrusions 40a, and the structures 40b, it is advantageous that the surface area of the outer surface S1 of the plate 40 contacting the atmosphere is increased. Accordingly, the outer surfaces S1 of the plates 40 of FIGS. 4 and 5 can be processed to be uneven as shown in FIG. 6. The increased surface area of the outer surface S1 of the plate 40 increases the area available for heat transfer from the cathode 18 or the second diffusive layer 32 through the trenches 40c and the plate 40 to the atmosphere.

Also, as shown in FIG. 7, cooling grooves 50 can be formed at the position of the outer surface S1 of the plate 40 in which the protrusions 40a are formed. The shape of the cooling grooves 50 may be similar to that of the protrusions 40a. For example, when the protrusions 40a are circular cones, the cooling grooves 50 can also have the shape of circular cones. Again, the increased surface area of the outer surface S1 of the plate 40 increases the area available for heat transfer, thereby decreasing the time for cooling of the plate 40. The outer surface S1 may be formed to contain other cooling structures such as cooling fins or may have external heatsinks attached thereto.

As described above, as the area of the outer surface S1 contacting the atmosphere is increased by changing the shape of the outer surface S1 of the plate 40, the time to condense the water vapor collected in the trenches 40c to form water droplets is decreased. Thus, the cycle of the phase changes between liquid water and water vapor occurring at the cathode 18 or the second diffusive layer 32 and then at the plate 40 is shortened.

The circulation process of water occurring between the cathode 18 or the second diffusive layer 32 and the plate 40 in the fuel cell according to aspects of the present embodiment is shown in FIG. 8. Referring to FIG. 8, water vapor 52 generated by the cathode 18 contacts the surfaces of the protrusions 40a and the bottom 40cb of the trenches 40c. When the structures 40b are present in the trenches 40c, the water vapor 52 contacts and condenses on the structures 40b. The structures 40b increase the surface area on which the water vapor can condense and thereby increase the circulation of the water back to the cathode 18 or the second diffusive layer 32. The water vapor 52 is condensed and forms water droplets 54 on the surfaces of the protrusions 40a, the trenches 40c, and the structures 40b, if present. The water droplets 54 formed on the surfaces of the trenches 40c flow toward the cathode 18 or the second diffusive layer 32 along the surfaces of the protrusions 40a. The water supplied to the cathode 18 or the second diffusive layer 32 from the plate 40 is then supplied to the membranes 14 and 26 (FIG. 1) so that the membranes 14 and 26 remain properly hydrated. Thus, hydrogen ions (H+) generated at the anodes 10 and 24 (FIG. 1) pass through the membranes 14 and 26 and arrive at the cathodes 18 and 28 (FIG. 1).

The time necessary for the water vapor 52 to condense to the water droplets 54 decreases as the difference in temperature between the cathode 18 or the second diffusive layer 32 and the plate 40 increases. Thus, the distance between the cathode 18 or the second diffusive layer 32 and the bottoms 40cb of the trenches 40c is increased. That is, the depths of the trenches 40c are increased. However, when the wrinkles or grooves are in the outer surface S1 of the plate 40 thereby increasing the surface area of the outer surface S1, the distance between the bottoms 40cb of the trenches 40c or the depth of the trenches 40c can be decreased.

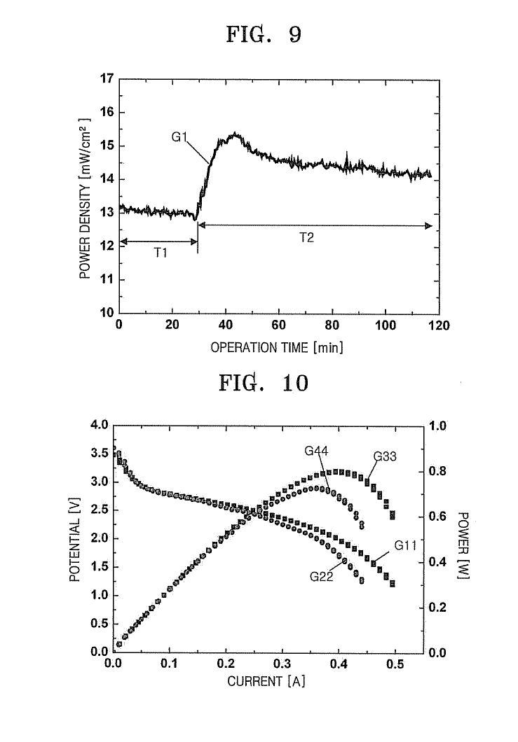

A monopolar fuel cell having the MEA A1 structure as indicated by the enlarged portion B shown in FIG. 1 (hereinafter, referred to as a test battery) and the plate 40 as shown in FIG. 2 was tested to generate FIGS. 9 and 10. Pure methanol vapor was used as the fuel supplied to the anode 24 of the test battery. Also, air was supplied to the surface of the cathode 28.

FIG. 9 is a graph showing the power density versus operation time. In a graph G1 of FIG. 9, a first time section T1 indicates the output power density before water is supplied from the plate 40. And, a second time section T2 indicates the output power density after water starts to be supplied from the plate 40.

Referring to the graph G1 of FIG. 9, it can be seen that the output power density when the operation of the fuel cell is in the second time section T2 (hereinafter, a second power density) is higher than the output power density when the operation of the fuel cell is in the first time section T1 (hereinafter, a first power density). The second power density peaks at about 15 mW/cm² and levels out at above 14 mW/cm². The first power density is about 13 mW/cm². The second power density is higher than the first power density by about 10%-15%. Thus, the condensation of water vapor on the plate 40 and the resultant flow of water from the plate 40 to the second diffusion layer 32 increase the power density output of the fuel cell.

FIG. 10 is a graph showing the voltage and power versus current measured during the above experiments. In FIG. 10, a first graph G11 indicates the voltage-current characteristics measured when the water is supplied to the cathode 32 from the plate 40. A second graph G22 indicates the voltage-current characteristics measured when the water is not supplied to the cathode 32 from the plate 40. A third graph G33 indicates the power-current characteristics measured when the water is supplied to the cathode 32 from the plate 40. A fourth graph G44 indicates the power-current characteristic measured when the water is not supplied to the cathode 32 from the plate 40.

When the first and second graphs G11 and G22 of FIG. 10 are compared, it can be seen that as current increases, the potential of graph G11 is greater than the potential of graph G22, at the same current. Thus, the monopolar fuel cell produced an increased potential at the same current when water was supplied from the plate 40 to the second diffusive layer 32. When the third and fourth graphs G33 and G44 of FIG. 10 are compared, it can be seen that the power of graph G33 is greater than the power of graph G44, at the same current. Therefore, the monopolar fuel cell generates more power at the same current when water is condensed on and supplied from the plate 40 to the second diffusive layer 32.

While this invention has been particularly shown and described with reference to aspects of the embodiments thereof, it will be understood by those skilled in the art that various changes in form and details, in particular, the plate 40, may be made therein without departing from the spirit and scope of the invention as defined by the appended claims. Also, the structure of the MEA A1 can be configured differently from the above-described structures and other constituent elements can be added to the structure. Also, heat removal pipes may be provided such that an evaporation portion of the heat pipe is located between the outer surface S1 of the plate 40 and the bottoms 40cb of the trenches 40c so as to accept heat from the plate.

As described above, the fuel cell according to aspects of the present invention includes the plate that is attached to the cathode and condenses the water vapor by collecting the water vapor generated from the cathode and supplies water to the cathode. Thus, by using the fuel cell according to aspects of the present invention, the amount of water lost from the cathode can be minimized and water can be supplied from the plate to the cathode. Accordingly, the output power density can be increased and the membrane may be sufficiently hydrated so as to properly transfer hydrogen ions (H+) to the cathode. Also, since the structure of the plate is simple, the manufacturing of the fuel cell is made easy.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A planar type fuel cell comprising:
a membrane electrode assembly including an electrolyte membrane, an anode, and a cathode; and
a plate attached to the cathode of the membrane electrode assembly, wherein the plate condenses water vapor generated by the cathode and supplies the condensed water to the cathode, and the plate resists the absorption of water.

2. The fuel cell of claim 1, wherein a space in which the water vapor generated from the cathode is collected and condensed is provided on the plate.

3. The fuel cell of claim 1, wherein the plate comprises a plurality of protrusions the tips of which contact the membrane electrode assembly, and the plate is separated from the membrane electrode assembly around the protrusions.

4. The fuel cell of claim 3, wherein the protrusions are arranged in a grid pattern.

5. The fuel cell of claim 3, wherein the protrusions are circular cones, polygonal cones, or pillars.

6. The fuel cell of claim 4, wherein wrinkles or grooves are formed on surfaces of the protrusions in a direction from the bottom of each of the protrusions toward the top thereof.

7. The fuel cell of claim 3, further comprising a plurality of structures formed on the plate in a grid pattern without contacting the membrane electrode assembly.

8. The fuel cell of claim 7, wherein the structures are located around each of the protrusions.

9. The fuel cell of claim 7, wherein a plurality of trenches are formed on the plate by the protrusions and the structures.

10. The fuel cell of claim 1, wherein wrinkles are formed on an outer surface of the plate.

11. The fuel cell of claim 10, wherein the wrinkles entirely cover the outer surface of the plate.

12. The fuel cell of claim 3, wherein wrinkles are formed on an outer surface of the plate.

13. The fuel cell of claim 7, wherein wrinkles are formed on an outer surface of the plate.

14. The fuel cell of claim 1, wherein a groove having the same shape as that of each protrusion is formed at a position of an outer surface of the plate to correspond to each protrusion.

15. The fuel cell of claim 7, wherein the structures are circular or polygonal.

16. The fuel cell of claim 7, wherein the structures are circular cones or polygonal cones.

17. The fuel cell of claim 3, wherein a groove having the same shape as that of each protrusion is formed at a position of an outer surface of the plate to correspond to each protrusion.

18. The fuel cell of claim 7, wherein a groove having the same shape as that of each protrusion is formed at a position of an outer surface of the plate to correspond to each protrusion.

19. The fuel cell of claim 3, wherein the protrusions form trenches in which air flows between the plate and the membrane electrode assembly.

20. The fuel cell of claim 7, wherein the protrusions and the structures form trenches in which air flows between the plate and the membrane electrode assembly.
